(19) United States
(12) Patent Application Publication
(10) Pub. No.: US 2020/0139611 A1
(43) Pub. Date: May 7, 2020

(54) Guide Pin for Machine Insertion of Plastic or Rubber Tubes into Shaping Mold and Device

(71) Applicant: MSV Systems CZ s.r.o., Liberec (CZ)

(72) Inventors: Ondrej Belohlavek, Liberec (CZ); David Tichy, Straz and Nisou (CZ); Marek Barvinek, Liberec (CZ)

(21) Appl. No.: 16/278,485

(22) Filed: Feb. 18, 2019

(30) Foreign Application Priority Data
Nov. 6, 2018 (EP) 18204564.1

(51) Int. Cl. B29C 53/82; B29C 53/08; B29C 31/00

(52) U.S. Cl. CPC B29C 53/82; B29C 33/505; B29C 31/002; B29C 53/08

(57) ABSTRACT

A guide mandrel is provided for machine insertion of plastic or rubber tubes into a shaping mold. The guide mandrel includes a rigid rear portion and a flexible front end portion, the flexible front end portion including an elastic front end member. A rear end of the guide mandrel is configured for mounting of the guide mandrel in a device for automatic insertion of the plastic or rubber tubes into a shaping mold. A device for automatic insertion of straight plastic or rubber tubes into a shaping mold using the guide mandrel is also provided.

### TECHNICAL FIELD

The invention relates to a guide mandrel used for machine insertion of plastic or rubber tubes into a shaping mold, the guide mandrel comprising a rigid rear portion and a flexible front end portion.

The invention also relates to a device for machine insertion of plastic or rubber tubes into a shaping mold with a guide mandrel which comprises a longitudinal frame, adapted to be fastened to an end element of a 3D manipulator, and means for inserting the tube into a labyrinth.

### BACKGROUND

For the bending of plastic or rubber tubes, molds comprising a molding labyrinth (hereinafter referred to as “labyrinth”) made of a durable material into which a straight tube is pressed to be shaped. After passing through the furnace/steam molding process and after cooling, the tube maintains the spatial shape of the labyrinth into which it was inserted at the beginning of the process. During the insertion of the straight tube into the spatially shaped labyrinth, the initially straight tube is subjected to bending or twisting or other stresses. So as to avoid undesirable deformations of the tube cross-section when inserting the straight plastic or rubber tube into the labyrinth, such as slumps or depressions in the tube wall in the bends, or other unwanted deformations, a reinforcing elastic body is inserted into the tube cavity along the entire length of the tube (e.g., a spring which with its outer surface supports the inner wall of the tube pressed into the labyrinth), the elastic body being bent according to the shape of the labyrinth along with the shaped tube pressed into the labyrinth. After the shaping process of the tube and the stabilization of the form of the shaped tube, the inner elastic body of the shaped tube is pulled out, which requires considerable strength and also creates a risk of damage or deformation of the tube already formed. Another disadvantage, particularly in thin-walled tubes, is the risk of deformation of the surface of the shaped tube exactly according to the surface of the elastic body, e.g. a spring. Another disadvantage is that for each shaped tube, one elastic body is required throughout the shaping of the tube, which also involves high financial, logistic and storage requirements of the process with the inserted elastic bodies. Last but not least, the step of inserting the elastic body into the tube and removing it from the tube is a phase in the process which should be omitted to shorten the working cycle (tact time).

The aim of the invention is to eliminate or at least reduce the disadvantages of the background art.

### SUMMARY OF THE INVENTION

Objects and advantages of the invention will be set forth in part in the following description, or may be obvious from the description, or may be learned through practice of the invention.

The aim of the invention is achieved by a guide mandrel for machine insertion of plastic or rubber tubes into a shaping mold, whose principle consists in that the flexible front end portion is formed by an elastic front end portion, and whereby the guide mandrel is adapted to be mounted at its rear end in a device for automatic insertion of plastic or rubber tubes into the shaping mold.

The principle of the device for automatic insertion of straight plastic or rubber tubes into the mold is that on a frame is mounted at its rear end the guide mandrel of the shaped tube, which is adapted to put on the tube, whereby the guide mandrel is provided with an elastic front end portion adapted to maintain the presence of the mandrel in the tube at the bending point and to minimize the ovality of the bent tube. The elastic front end portion of the guide mandrel is associated with an inserting pulley mounted on the frame, wherein at least one pair of guide pulleys are mounted on the frame along the sides of the guide mandrel in the area between the inserting pulley and the rear end of the guide mandrel.

An advantage of the present invention is to enable high-quality machine insertion of plastic or rubber tubes even into spatially complex 3D shaping molds—labyrinths, effectively preventing undue deformation of the tube cross-section, such as a slump or depression of the tube walls in the bends or other undesirable deformations, thereby eliminating the need to leave the inner mandrel in the tube throughout the molding process, as well as the need to remove the inner mandrel after shaping the tube and also eliminating the risk of damaging the shaped tube when removing the inner mandrel. The step of inserting an elastic body into each tube prior to insertion into the mold and removing the elastic body from each tube has been left out by the present invention and a further reduction in the working cycle is achieved. In thin-walled tubes, the risk of deformation of the shaped tube is virtually eliminated, precisely copying the surface of the inserted elastic body during the shaping process, i.e. during heating and subsequent cooling with the relaxation of internal stresses.

### BRIEF DESCRIPTION OF THE DRAWINGS

The invention is schematically represented in the drawings, where:

FIG. 1 shows a spatial view of an exemplary embodiment of a device for automatic insertion of plastic or rubber tubes into a shaping mold;

FIG. 2 is a side view of the device with the first embodiment of the guide mandrel in longitudinal section; and

FIG. 3 shows the second embodiment of the guide mandrel in longitudinal section.

### DETAILED DESCRIPTION

Reference will now be made to embodiments of the invention, one or more examples of which are shown in the drawings. Each embodiment is provided by way of explanation of the invention, and not as a limitation of the invention. For example features illustrated or described as part of one embodiment can be combined with another embodiment to yield still another embodiment. It is intended that the present invention include these and other modifications and variations to the embodiments described herein.

The invention will be described with reference to exemplary embodiments of a guide mandrel for machine insertion of plastic or rubber tubes into a shaping mold and an exemplary embodiment of a device for automatic insertion of straight plastic or rubber tubes into the shaping mold—the labyrinth.

The device for automatic insertion of straight plastic or rubber tubes into the shaping mold—the labyrinth—comprises a longitudinal frame 1 which is adapted to be fastened to the end element of a 3D manipulator (not shown). In the illustrated embodiment, the frame 1 for fastening to the end element of the 3D manipulator (not shown) has a clamping projection 10 on the upper side of the front portion of the frame 1. In an unillustrated exemplary embodiment, the clamping projection 10 is provided on a different part of the frame 1, or is formed by another suitable method.

On the lower side of the frame 1, a guide mandrel (pin) 6 of the shaped tube 3 is mounted at its rear end 61. The guide mandrel 6 is located in the direction of the frame 1 length towards the front end 11 of the frame 1, where the guide mandrel 6 is provided with an elastic front end portion 60 adapted to maintain the presence of the mandrel 6 in the tube 3 at the bending point and to minimize the ovality of the bent tube 3, or minimizing slumps or depressions of the tube material 3 in the bending region.

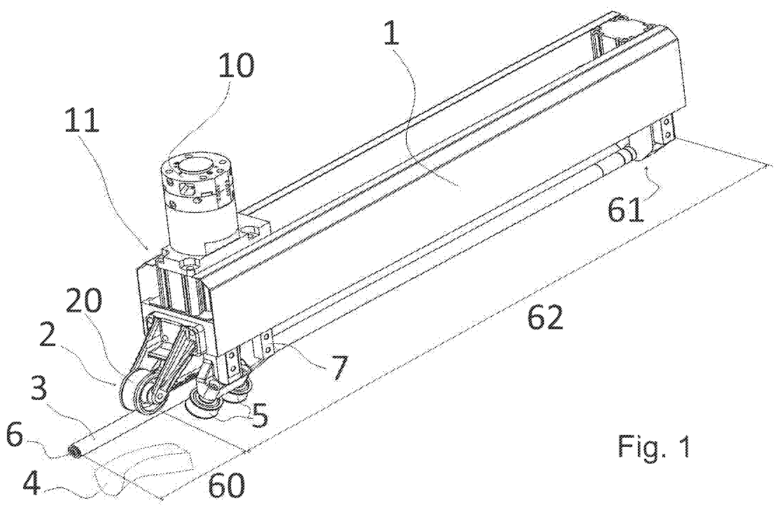

On the frame 1, ideally at its front end 11, is rotatably mounted an inserting pulley 2, which serves to press the shaped plastic or rubber tube 3 into the labyrinth 4, which is in FIG. 1 indicated only schematically by a weak dashed line. The inserting pulley 2 is associated by its pulley surface 20 with the guide mandrel 6, ideally in the region of transition of the rigid (under normal conditions inflexible) rear portion 62 of the guide mandrel 6 into the elastic front end portion 60 of the guide mandrel 6. The position and direction of the inserting pulley 2 and of the guide mandrel 6, including the elastic front portion 60 of the guide mandrel 6, relative to the labyrinth 4 is controlled by the 3D manipulator (not shown) of the frame 1 according to the control program performed by a control device of the 3D manipulator.

At least one pair of guide pulleys 5 are further mounted on the frame 1 along the sides of the guide mandrel 6 in the area between the inserting pulley 2 and the rear end 61 of the guide mandrel 6. The guide mandrel 6, as viewed from the front, passes through the space defined by the inserting pulley 2 and the guide pulleys 5, which increases the stability of the attachment of the guide mandrel 6 at its rear end to the frame 1, in fact the stability of overhung (free-end) mounting of the guide mandrel 6 on the frame 1, which allows to guide the shaped tube 3 placed on the guide mandrel 6, as will be described in more detail hereinafter.

In the illustrated embodiment, at least one auxiliary support 7 of the mandrel 6 and of the tube 3 is situated in the area between the guide pulleys 5 and the rear end 61 of the guide mandrel 6 mounted on the frame 1. The auxiliary support 7 is particularly suited to large lengths of the mandrel 6 and the tube 3. In an unillustrated exemplary embodiment, the device is implemented without the auxiliary support 7.

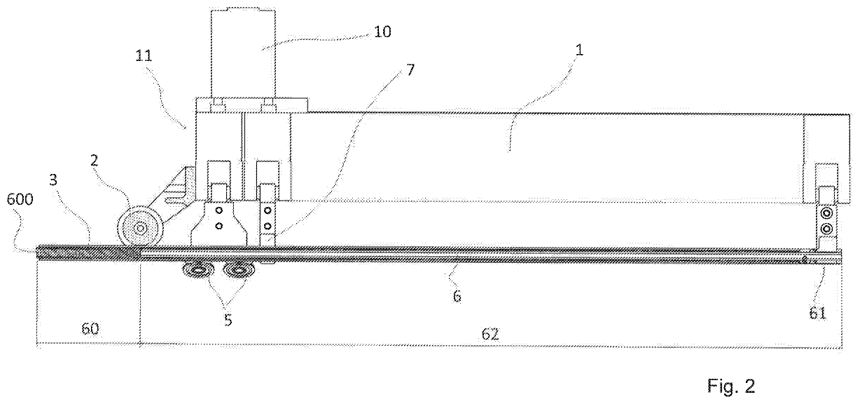

As shown in FIGS. 2 to 4 and as previously mentioned, the guide mandrel 6 has an elastic front end portion 60.

In the embodiment of FIG. 2, the elastic front end portion 60 of the guide mandrel 6 is formed by a cylindrical spring 600, which is placed on the guide mandrel 6 along its entire length. The rigid rear portion 62 of the guide mandrel 6 has a smaller diameter and the cylindrical spring 600 is placed directly on it, whereby the front portion of the cylindrical spring 600 extends beyond the front end of the rigid rear portion 62 of the guide mandrel 6. The front portion of the cylindrical spring 600, which is not put on the rigid rear portion 62 of the guide mandrel 6, constitutes the elastic front end portion 60 of the guide mandrel 6, whereby the front end of the elastic front portion is located at a distance before the inserting pulley 2, as required by the bent tube 3.

In an unillustrated embodiment, which is a modification of the embodiment of FIG. 2, the elastic front end portion 60 of the guide mandrel 6 is formed by a cylindrical spring 600, which, at one end thereof, is secured to the front end of the rigid rear portion 62 of the guide mandrel 6, whereby the rigid rear portion 62 of the guide mandrel 6 is free, i.e., it is not overlaid by the spring 600 or overlapped only on a limited length. The rigid rear portion 62 of the guide mandrel 6 has either a diameter of the inner diameter of the inserted shaped tube 3 or has a smaller diameter, which is advantageous to reduce the friction between the mandrel 6 and the tube 3 while the tube 3 is being inserted into the labyrinth 4. In this embodiment, too, the cylindrical spring 600 is located with its front portion at a distance before the inserting pulley 2, as required by the bent tube 3.

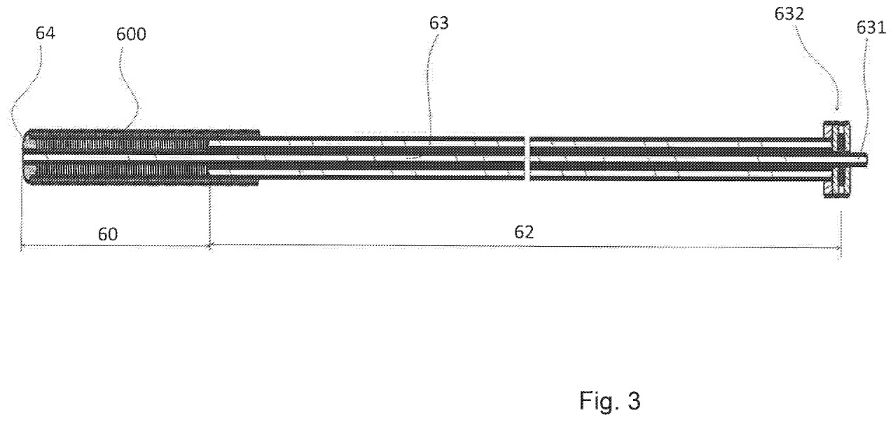

FIG. 3 shows an embodiment of the guide mandrel 6, which comprises a hollow rigid rear portion 62, to whose front end is attached a cylindrical spring 600 constituting a elastic front end portion 60 of the guide mandrel 6. A resilient tensioning means 63 such as a steel cable, passes through the cavity of the hollow rigid rear portion 62 of the guide mandrel 6 and through the cavity of the cylindrical spring 600. The resilient tensioning means 63 is mounted at its front end 630 in the front disc 64, whose rear side rests against the front end of the cylindrical spring 600. The front side of the front disc 64 is adapted for receiving the tube 3. The resilient tensioning means 63 is at its rear end 631 fastened to the rear end of the hollow rigid rear portion 62 of the guide mandrel 6, for example by means of a suitable disc 632 or a system of discs. By tightening the resilient tensioning means 63, for example, the compression of the cylindrical spring 600 can be affected, thereby adjusting the stiffness of the elastic front end portion 60 of the guide mandrel 6 etc.

The insertion of the tube 3 into the labyrinth 4 starts with putting the entire tube 3 on the guide mandrel 6, ideally as far as to its rear end 61. Ideally, the length of the mandrel 6 corresponds to the length of the inserted tube 3. Subsequently, the device approaches the front end of the labyrinth 4 and the front end of the tube 3 is clamped in the clamping device at the front end of the labyrinth 4. Afterwards, the 3D device is moved in a controlled manner by the inserting pulley 2 along the labyrinth and the tube 3 is gradually pressed into the 3D shaping labyrinth 4 by the inserting pulley 2. Simultaneously, the tube 3 is bent according to the shape of the labyrinth 4 and at the same time this bending of the tube is supported from the inside of the tube 3 by the elastic front end portion 60 of the guide mandrel 6, which is along its length from the inserting pulley 2 towards the front end of the mandrel 6 bent as required and according to 3D shape of the labyrinth 4. At the same time, the tube 3 gradually “slips” off the mandrel 6 as the insertion into the labyrinth 4 proceeds, while the elastic front end portion 60 of the guide mandrel 6 moves along with the inserting pulley 2 towards the end of the labyrinth 4 until the whole length of the tube 3 is inserted into the labyrinth 4.

### INDUSTRIAL APPLICABILITY

The solution can be used especially for machine insertion of plastic or rubber tubes into shaping molds, such as labyrinths and similar 3D shaping tools.

Modifications and variations can be made to the embodiments illustrated or described herein without departing from the scope and spirit of the invention as set forth in the appended claims.

1-12: (canceled)

13. A guide mandrel for machine insertion of plastic or rubber tubes into a shaping mold, the guide mandrel comprising:
a rigid rear portion;
a flexible front end portion, the flexible front end portion comprising an elastic front end member; and
a rear end configured for mounting of the guide mandrel n a device for automatic insertion of plastic or rubber tubes into a shaping mold.

14. The guide mandrel according to claim 13, wherein the elastic front member comprises a cylindrical spring fitted onto the rigid rear portion such that the cylindrical spring extends along an entire length of the guide mandrel, the rigid rear portion comprising a smaller diameter than the cylindrical spring, a front portion of the cylindrical spring extending beyond a front end of the rigid rear portion to define the flexible front end portion.

15. The guide mandrel according to claim 13, wherein the elastic front end member comprises a cylindrical spring having a rear end fastened to a front end of the rigid rear portion, a front portion of the cylindrical spring extending beyond a front end of the rigid rear portion to define the flexible front end portion.

16. The guide mandrel according to claim 15, wherein the rigid rear portion has a smaller diameter than an inner diameter of the plastic or rubber tube inserted onto the guide mandrel to be shaped.

17. The guide mandrel according to claim 13, wherein the rigid rear portion is hollow, the elastic front end member comprising a cylindrical spring fastened to a front end of the hollow rigid rear portion, and further comprising a tensioning member passing through the hollow rigid rear portion and the cylindrical spring, a front end of the tensioning member mounted to front disc engaged with a front end of the cylindrical spring a front side of the front disc adapted for insertion of the plastic or rubber tube thereon, a rear end of the tensioning device attached to a rear end of hollow rigid rear portion.

18. A device for automatic insertion of straight plastic or rubber tubes into a shaping mold, comprising:
a guide mandrel, the guide mandrel further comprising:
a rigid rear portion;
a flexible front end portion, the flexible front end portion comprising an elastic front end member; and
a rear end configured for mounting of the guide mandrel in a device for automatic insertion of plastic or rubber tubes into a shaping mold;
a longitudinal frame, a rear end of the guide mandrel mounted to the frame;
wherein the elastic front end member is adapted to minimize ovality of the plastic or rubber tube and maintain presence of the guide mandrel in the plastic or rubber tube at bending points in the shaping mold;
an inserting pulley mounted at a front end of the frame; and
a pair of guide pulleys mounted on the frame along opposite sides of the guide mandrel between the inserting pulley and the rear end of the guide mandrel.

19. The device according to claim 18, wherein the inserting pulley comprises a pulley surface that engages with the guide mandrel at a transition region between the rigid rear portion and the flexible front end portion of the guide mandrel.

20. The device according to claim 18, further comprising an auxiliary support for the guide mandrel and plastic or rubber tube inserted thereon situated between the guide pulleys and the rear end of the guide mandrel.

21. The device according to claim 18, wherein the elastic front end member of the guide mandrel comprises a cylindrical spring fitted onto the rigid rear portion such that the cylindrical spring extends along an entire length of the guide mandrel, the rigid rear portion comprising a smaller diameter than the cylindrical spring, a front portion of the cylindrical spring extending beyond a front end of the rigid rear portion to define the flexible front end portion.

22. The device according to claim 18, wherein the elastic front end member of the guide mandrel comprises a cylindrical spring having a rear end fastened to a front end of the rigid rear portion, a front portion of the cylindrical spring extending beyond a front end of the rigid rear portion to define the flexible front end portion.

23. The device according to claim 22, wherein the rigid rear portion has a smaller diameter than an inner diameter of the plastic or rubber tube inserted onto the mandrel to be shaped.

24. The device according to claim 18, wherein the rigid rear portion is hollow, the elastic front end member comprising a cylindrical spring fastened to a front end of the hollow rigid rear portion, and further comprising a tensioning member passing through the hollow rigid rear portion and the cylindrical spring, a front end of the tensioning member mounted to front disc engaged with a front end of the cylindrical spring, a front side of the front disc adapted for insertion of the plastic or rubber tube thereon, a rear end of the tensioning device attached to a rear end of hollow rigid rear portion.
